(19) United States
(12) Patent Application Publication
(10) Pub. No.: US 2025/0361968 A1
(43) Pub. Date: Nov. 27, 2025

(54) ASSEMBLY AND METHOD FOR REPAIRING PIPE USING AN EXPANSION RESTRICTOR

(71) Applicant: Perma-Liner Industries, LLC, Clearwater, FL (US)

(72) Inventor: Chris Ras, Elk Grove Village, IL (US)

(73) Assignee: Perma-Liner Industries, LLC, Clearwater, FL (US)

(21) Appl. No.: 18/672,475

(22) Filed: May 23, 2024

(51) Int. Cl. F16L 55/165; B29C 73/32

(52) U.S. Cl. CPC F16L 55/1654; B29C 73/32

(57) ABSTRACT

An assembly and method for repairing a pipeline. The assembly may include a sleeve positioned between a bladder and a liner. The sleeve includes a first portion having a larger diameter than a second portion. The larger diameter at the first portion of the sleeve allows the sleeve to expand outward with less pressure. Upon the introduction of fluid pressure into the bladder, the bladder, sleeve, and liner expand radially outward at the first portion of the sleeve first. Then, as pressure inside the bladder increases, the remainder of the assembly expands radially outward toward the pipe in a serial fashion longitudinally away from the first portion. In this manner the user can control which area of the assembly is inflated and expanded first by positioning the first portion of the sleeve at the appropriate location.

### BACKGROUND

The present invention relates to a device and method for repairing pipe, such as underground sewer pipe and the like. Prior methods for repairing damaged pipelines include moving a liner impregnated with a liquid material capable of curing and hardening to the position within the pipe where the damaged portion is located. The liner is urged in an outward radial direction into contact with the pipeline being repaired and the liquid material impregnating the liner tube is permitted to cure and harden. The liner forms an interior liner in the pipe for the pipeline being repaired.

One existing method for repairing pipelines and other structures includes the use of a liner having a felt layer on its inside and having a protective layer made of polymer or other plastic material on its outside. The liner tube is vacuum-impregnated with a resin mix in what is commonly referred to as a “wet-out” process. Just prior to wetting-out the liner, a catalyst is mixed with the resin so as to activate the resin and cause it to begin curing and hardening. The resin impregnated liner is then positioned in the pipeline and an expandable bladder is inflated to urge the liner outward into contact with the inner wall of the damaged pipe. Once the resin cures and hardens, the liner provides a new lining for the pipeline. Some resins are set to cure at ambient temperatures. In recent years the industry has begun impregnating the liner with light-activated resin, then shining ultra violet (UV) (or other suitable wavelength) light toward the liner to begin the curing process after the liner is placed within the pipeline. Light-activated resins help overcome certain drawbacks in other types of resins because the resin in the impregnated liner does not begin to cure until it is exposed to the UV light.

One problem with existing repair systems is that fluid such as water or air can get trapped between the liner and the pipe wall, especially at pipe bends or elbows. The bladder inflates and presses the liner against the pipe wall on either side of the fluid pocket. The fluid cannot escape either direction, so the bladder inflates the liner against the fluid pocket instead of fully inflating the liner against the wall of the pipe. This decreases the internal diameter of the liner which can lead to flow problems and restrictions through the newly lined pipe.

Therefore, there is a need for an improved method and assembly for repairing pipes which overcomes these and other problems in the art.

### SUMMARY

According to one aspect of the invention, a sleeve is provided for repairing a pipeline. The sleeve is configured to be used with a repair assembly. The repair assembly includes the sleeve positioned between a bladder and a liner. The sleeve is made from an expandable material, such as an elastomer or polymer. The sleeve comprises a longitudinal middle portion between two end portions. The sleeve also comprises a first portion having a first diameter and a second portion having a second diameter. The first diameter is greater than the second diameter. In some embodiments the larger diameter first portion is near the middle portion of the sleeve, causing the sleeve to have the shape of a prolate spheroid, oval, or sphere, even in an unstretched state. In other embodiments the larger diameter first portion is near one or both of the end portions of the sleeve. The sleeve is configured to expand outward with less pressure at the first portion. Conversely, more pressure is required to expand the sleeve along the second portion.

Therefore, upon the introduction of fluid pressure into the bladder, the bladder, sleeve, and liner begin expanding radially outward toward the pipe at the first portion before the second portion because of the reduce pressure required to expand the sleeve at that location. Then, as pressure inside the bladder increases, the remainder of the assembly expands radially outward toward the pipe in a serial or progressive fashion longitudinally away from the first portion. In this manner the user can control which area of the assembly is expanded/inflated first by positioning the larger diameter first portion of the sleeve at the appropriate location.

According to another aspect of the invention, an assembly is provided for repairing a pipeline. The assembly is configured to be positioned in the pipeline by any suitable means, including by pushing or pulling the assembly into the pipeline as part of a packer. The assembly includes a sleeve positioned at least partially over a bladder. Some embodiments further include a liner positioned at least partially over the sleeve. The bladder is a fluid sealed bladder capable of expanding upon introducing a fluid, such as air, into the bladder. The bladder may be part of the packer. The bladder and sleeve are made from an expandable material, such as an elastomer or polymer, and the sleeve may be made from the same material as the bladder. The bladder is positioned radially inward of the sleeve and the liner is positioned radially outward of the sleeve; however, the components do not necessarily need to be adjacent to each other. The liner is configured to be impregnated with a resin capable of curing and hardening. The sleeve has a longitudinal middle portion between two end portions. The sleeve also has a first portion and a second portion. The first portion has a first diameter and the second portion has a second diameter. The first diameter is larger than the second diameter. In some embodiments the larger diameter first portion is near the middle portion of the sleeve, causing the sleeve to have the shape of a prolate spheroid, oval, or sphere, even in an unstretched state. In other embodiments the larger diameter first portion is near one or both of the end portions of the sleeve. The sleeve is configured to expand outward with less pressure at the first portion because of its larger diameter. Conversely, more pressure is required to expand the sleeve along the second portion. Therefore, upon the introduction of fluid pressure into the bladder, the bladder, sleeve, and liner expand radially outward at the first portion first because of the reduce pressure required to expand the sleeve at that location. Then, as pressure inside the bladder increases, the remainder of the assembly expands radially outward toward the pipe in a serial or progressive fashion longitudinally away from the first portion. In this manner the user can control which area of the assembly is expanded/inflated first by positioning the larger diameter first portion of the sleeve at the appropriate location. In some embodiments the first portion of the sleeve (having the larger diameter) is positioned near the longitudinal center of the liner so radial expansion of the repair assembly begins near the middle of the liner and progresses serially outward toward the ends (longitudinally), pushing air, water, or other fluid from the center outward toward the ends of the assembly.

Another aspect of the invention is similar to the aspects described above, except the sleeve and the bladder are the same component. In other words, the sleeve and bladder are combined into a single component referred to herein as an integrated bladder sleeve. The integrated bladder sleeve may comprise the bladder assembly of a packer. The integrated bladder sleeve has a first portion and a second portion. The first portion has a first diameter and the second portion has a second diameter. The first diameter is larger than the second diameter. In some embodiments the larger diameter first portion is near the middle portion of the integrated bladder sleeve, causing the integrated bladder sleeve to have the shape of a prolate spheroid, oval, or sphere, even in an unstretched state. In other embodiments the larger diameter first portion is near one or both of the end portions of the integrated bladder sleeve. The integrated bladder sleeve is configured to expand outward with less pressure at the first portion because of its larger diameter. Conversely, more pressure is required to expand the integrated bladder sleeve along the second portion. Therefore, upon the introduction of fluid pressure into the bladder, the bladder, integrated bladder sleeve, and liner expand outward at the first portion first because of the reduce pressure required to expand the integrated bladder sleeve at that location. Then, as pressure inside the bladder increases, the remainder of the assembly expands radially outward toward the pipe in a serial or progressive fashion longitudinally away from the first portion. In this manner the user can control which area of the assembly is expanded/inflated first by positioning the larger diameter first portion of the integrated bladder sleeve at the appropriate location.

Another aspect of the present invention includes a method of making and using the assemblies described above for repairing a pipeline. The method includes creating a sleeve (or integrated bladder sleeve) having has a first portion and a second portion. The first portion has a first diameter and the second portion includes a second diameter that is different from the first diameter. Impregnating the liner with a resin capable of curing and hardening, then positioning the liner over the sleeve. Positioning the assembly in the pipe at a damaged portion needing repair, then inflating the bladder using fluid pressure causing the assembly to expand outward toward the inside wall of the pipe. In some embodiments the assembly is positioned in the pipe so the first portion of the sleeve is positioned within a bend or curve in the pipe. The first portion of the sleeve (having the larger diameter) expands first causing the bladder to urge the liner radially outward toward the pipe at that location, but not at other locations along the length of the assembly. Additional fluid pressure is introduced into the bladder to serially expand the assembly longitudinally away from the first portion in a progressive fashion until the remaining portions of the assembly are properly inflated and positioned. After the liner has cured and hardened, removing the packer, bladder, and sleeve from the pipe.

### BRIEF DESCRIPTION OF THE DRAWINGS

FIG. 1 is a perspective view of a sleeve comprising a first portion having a first diameter and a second portion having a second diameter.

FIG. 2 is a side view of a repair assembly having a liner wrapped around a portion of the sleeve.

FIG. 3 is a section view of the repair assembly shown in FIG. 2 before inflation.

FIG. 4 is a section view of the repair assembly shown in FIG. 2 partially inflated.

FIG. 4A is a section view of the repair assembly shown in FIG. 2 fully inflated.

FIG. 5 is a section view of the repair assembly of FIG. 2 where the first portion of the sleeve is positioned at a pipe bend.

FIG. 6 is a section view similar to FIG. 5 but showing the repair assembly partially inflated.

FIG. 7 is a section view similar to FIG. 5 but showing the repair assembly fully inflated.

### DETAILED DESCRIPTION

The invention generally relates to assemblies and methods for repairing a pipeline 11. The repair assembly 13 is configured to be positioned in the pipeline 11 by any suitable means, including by pushing or pulling the assembly 13 into the pipeline 11.

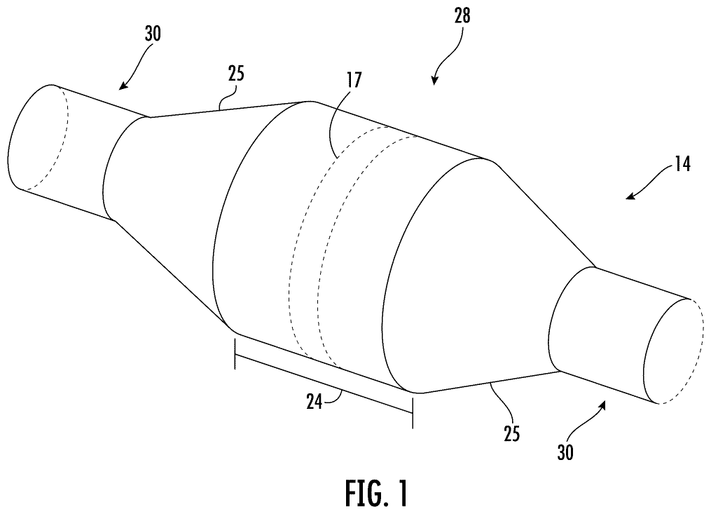

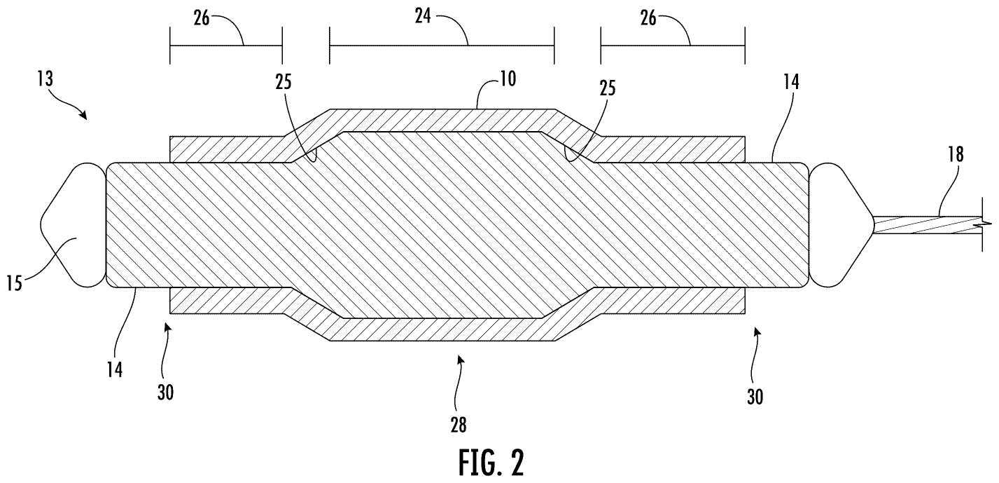

One embodiment generally relates to a sleeve 14 configured to be used with a repair assembly 13. The sleeve 14 is configured to be positioned between a bladder 12 and a liner 10. The sleeve 14 generally serves to help selectively restrict the expansion of the repair assembly 13 to allow controlled inflation upon introduction of fluid to the bladder 12. FIG. 1 shows the sleeve 14 apart from the rest of the repair assembly 13 in a relaxed or unstretched state. The sleeve 14 includes a longitudinal middle portion 28 between two end portions 30. The sleeve 14 also includes a first portion 24 having a first diameter D1 and a second portion 26 having a second diameter D2. The first diameter D1 is greater than the second diameter D2. Some embodiments of the sleeve 14 include one or more intermediate portions between the first portion 24 and the second portion 26. The intermediate portions having diameters between the first diameter D1 and the second diameter D2. In some embodiments the diameter of the sleeve 14 is tapered between the first diameter D1 and the second diameter D2 giving the sleeve the shape of a prolate spheroid, oval, or sphere a shown best in FIGS. 1 and 2. The tapered portions are shown by reference number 25. The tapered portions 25 include a plurality of decreasing diameters along the length of each taper. The invention, therefore, it not limited to a sleeve 14 having only two diameters D1, D2. Instead, the sleeve 14 may have a plurality of diameters along its length to control the expansion and produce the squeegee action desired by the user.

FIGS. 1 and 2 show the first portion 24 of the sleeve 14 near the middle portion 28 of the sleeve 14. In other words, the part of the sleeve 14 having the larger diameter D1 extends along a length near the longitudinal middle 28 of the sleeve 14. In other embodiments the first portion 24 (having the larger diameter D1) is positioned near one or both end portions 30 of the sleeve 14. The first portion of the sleeve 14 may extend longitudinally along the length of the sleeve 14 a predetermined distance, such as the length of the liner 10 or the length of a bend in the pipe 11.

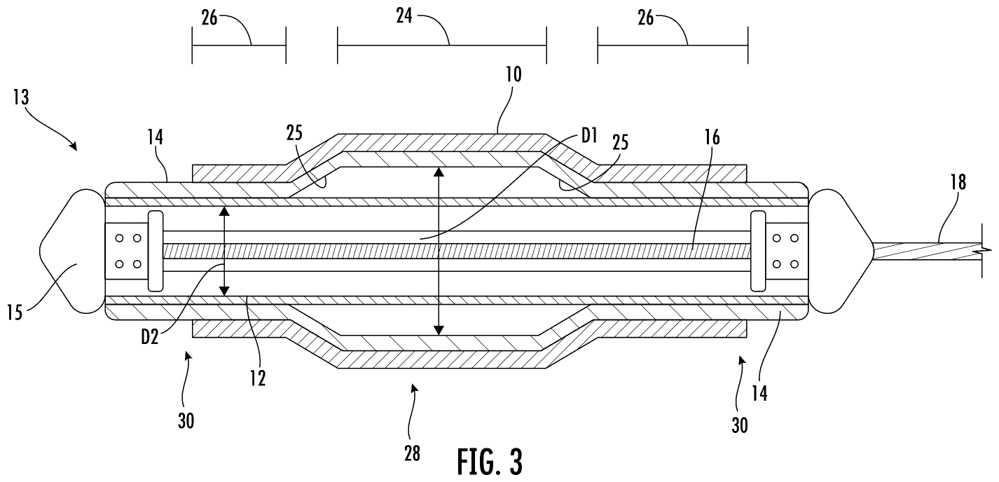

FIGS. 3-7 are section views showing other components of the repair assembly 13. The bladder 12 is a fluid sealed bladder 12 capable of expanding upon introducing a fluid, such as air, into the bladder 12. Fluid pressure (such as air pressure) may be introduced into the bladder 16 through tube 18, which may also be used to position (push/pull) the repair assembly 13 in the pipe 11 and communicate power to the lighting assembly 16. The bladder 12 may be part of the packer 15. The bladder 12 and sleeve 14 are made from an expandable material, such as an elastomer or polymer, and the sleeve 14 may be made from the same material as the bladder 12. The bladder 12 is positioned radially inward of the sleeve 14 and the liner 10 is positioned radially outward of the sleeve 14, however, the components do not necessarily need to be adjacent to each other. As shown in FIG. 1, one embodiment of the sleeve 14 includes one or more openings 17 around the circumference of the sleeve 14. The opening(s) 17 provide(s) a conduit to release air or other fluid trapped between the bladder 12 and the sleeve 14.

In some embodiments the sleeve 14 and the bladder 12 are the same component. In other words, the sleeve 14 and bladder 12 are combined into a single component referred to herein as an integrated bladder sleeve. The integrated bladder sleeve serves the functions of the sleeve 14 and the bladder 12. The integrated bladder sleeve looks similar to the sleeve 14 shown in FIG. 1, except it does not include any openings 17 since it is fluid impermeable and must be able to expand upon introducing fluid to serve the function of the bladder 12.

The liner 10 is configured to be impregnated with a resin capable of curing and hardening. The liner 10 is comprised of a felt layer, which is the lining surface that contacts the interior surface of the host pipe, and a polymer coating is on the opposite surface. The felt layer of the liner 10 is configured to be impregnated with the curable resin. The liner 10 may be comprised of what is initially a flat sheet of material wrapped around the outside of the bladder 12. The liner 10 may include overlapping edges to form a tube.

In some embodiments the resin is a light-activated resin having light-activated initiators embodied therein and the assembly further includes a lighting assembly 16 positioned within the bladder 12. The one or more light-activated initiators are set to begin curing the resin upon exposure to one or more predetermined wavelengths of light generated by the lighting assembly 16. The one or more wavelengths could be ultra-violate (UV), infrared (IR), violet or blue light (near the end of the visible spectrum), or any other suitable wavelength. In embodiments using light-curing, the bladder 12 and sleeve 14 are made from a light-permeable material which allows one or more wavelengths of light to pass through to the light-activated initiators impregnated in the liner 10. The bladder 12 and sleeve 14 material need not be translucent or transparent as long as the wavelength(s) of light which triggers the light-activated initiator is allowed to pass through. In some embodiments the bladder material allows a first wavelength such as UV to pass through but prevents a second wavelength such as visible light from passing through. Selectively allowing only certain wavelengths of light to pass through the bladder 12 and sleeve 14 help ensure curing is only initiated at the proper time.

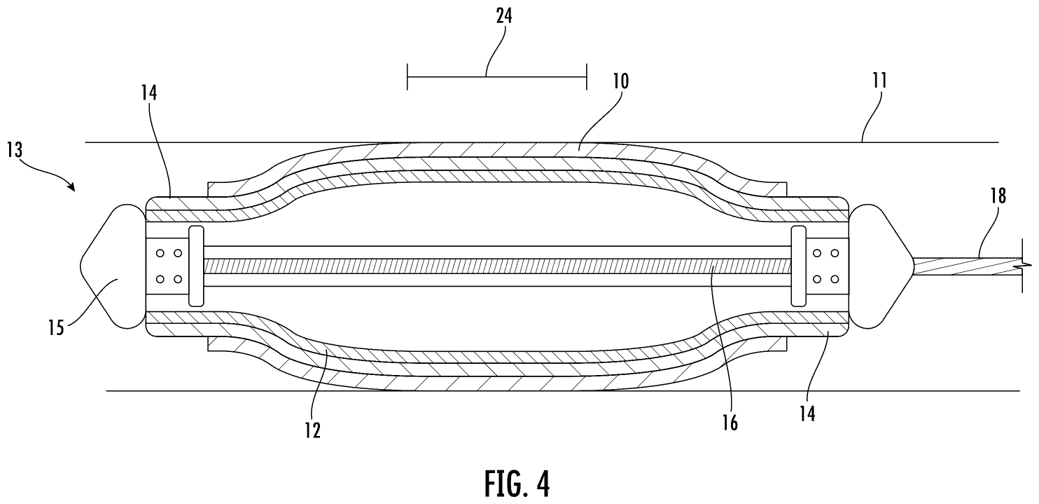

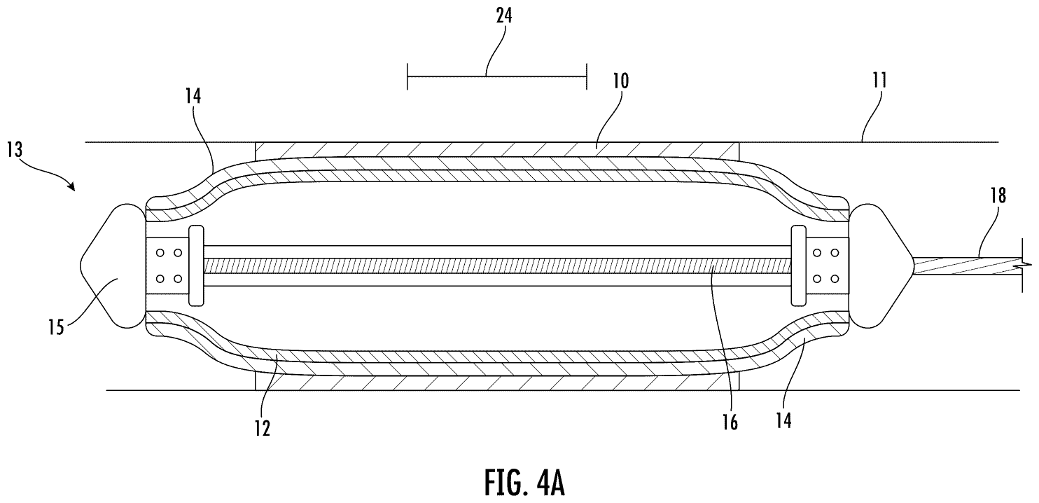

FIG. 3 shows the repair assembly 13 before inflation. The length and position of the first portion 24 of the sleeve 14 is designated by reference number 24 and the second portions 26 of the sleeve are designated by reference number 26 since the diameter of the sleeve 14 is not easily visible in some views. FIG. 4 shows the repair assembly 13 positioned within a pipe 11 wherein the assembly 13 is partially inflated. It takes less fluid pressure to expand the sleeve 14 at the first portion 24 because of the larger diameter D1 of the sleeve 14 at that location. Conversely, more pressure is required to expand the sleeve 14 along the second portion 26 of the sleeve 14 having the smaller diameter. Therefore, upon the introduction of fluid pressure into the bladder 12, the bladder 12, sleeve 14, and liner 10 expand radially outward at the first portion 24 of the sleeve 14 first. Then, as pressure inside the bladder 12 increases, the remainder of the assembly 13 expands radially outward toward the pipe 11 in a serial or progressive fashion longitudinally away from the first portion 24. In this manner the user can control which area of the assembly 13 is inflated and expanded first.

As shown in FIGS. 4 and 4A, positioning the first portion 24 of the sleeve 14 near the longitudinal center of the assembly 13 helps to minimize fluid (water or air) pockets trapped between the liner 10 and the pipe 11. In other words, any fluid between the liner 10 and the pipe 11 will be pushed outward toward an end of the assembly 13 as the assembly 13 expands outward radially first at its longitudinal center then serially away from the center/first potion 24 toward the end portions 30. The serial expansion of the assembly 13 longitudinally away from the first portion 24 means the expansion of the second portion 26 of the sleeve 14 (having the narrower diameter D2) begins closest to the first portion 24, then outward toward the ends of the sleeve 14. As noted above, some embodiments include a sleeve 14 with tapered portions 25 having a plurality of decreasing diameters from the first portion 24 to the second portion 26. The tapered diameter of the tapered portions 25 help ensure the expansion occurs gradually and progressively from the first portion 24 longitudinally toward the ends of the sleeve 14. In other words, the expansion begins at the first portion 24, then the tapered portion(s) 25 expand(s) from their largest diameter end toward their smallest diameter end, then the second portion(s) 26 expand(s) from their end closest to the tapered portion(s) 25 outward toward the end(s) of the sleeve 14. In this manner the sleeve 14 may have a plurality of diameters along its length to control the expansion and produce the squeegee action desired by the user. As shown, the largest diameter portion of the sleeve 14 is near the middle portion 28 of the sleeve 14. However, the largest diameter may be near a first end portion 30 with a taper along the length of the sleeve 14 toward a second end portion 30. In some embodiments the sleeve 14 may include multiple first portions 24 having a larger diameter and multiple second portions 26 having a smaller diameter. In these embodiments expansion may occur first at multiple larger diameter portions at the same time.

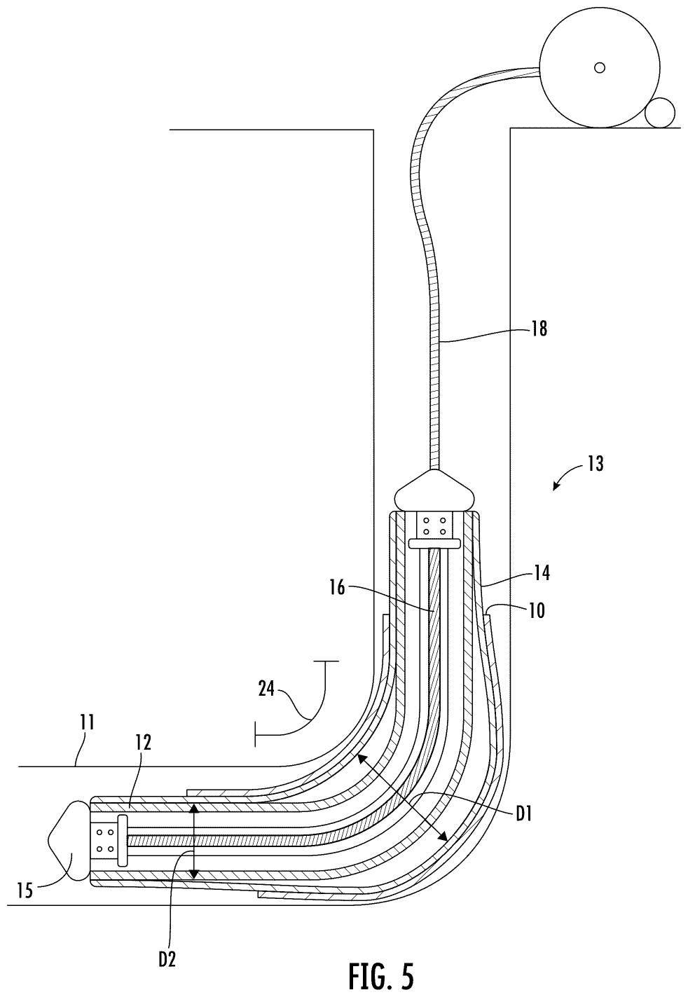

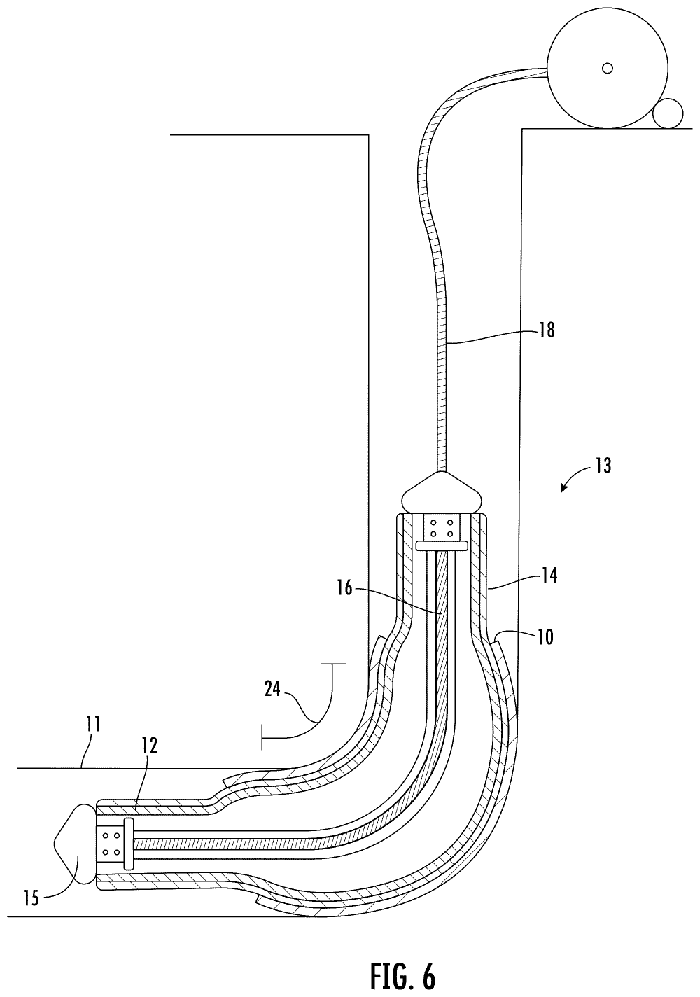

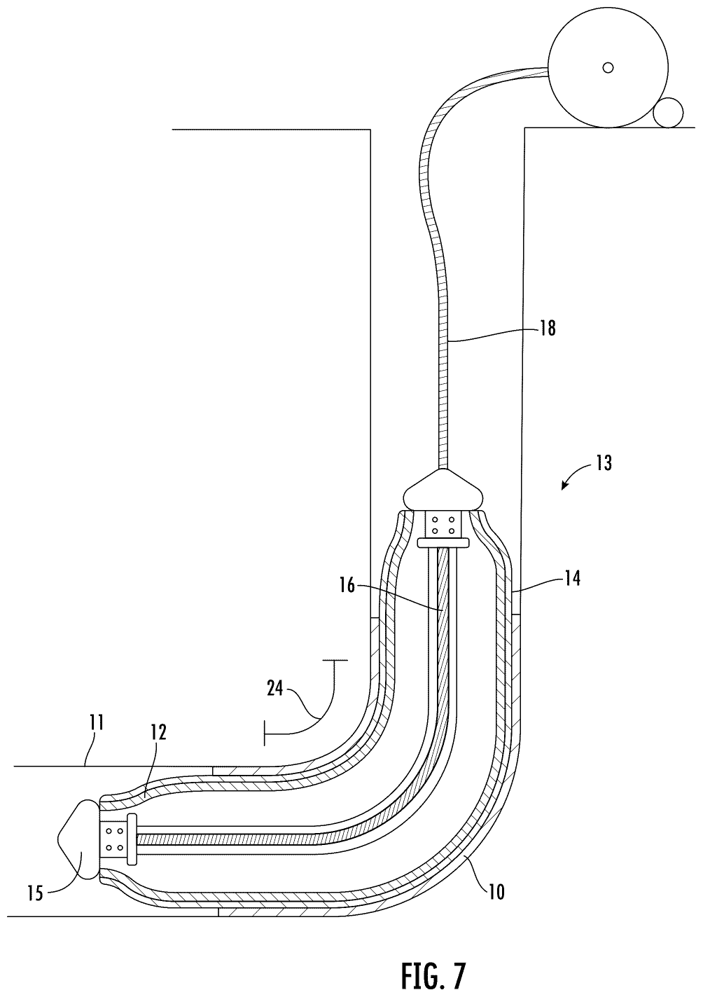

FIGS. 5-7 show the repair assembly 13 positioned at a bend in the pipeline 11. The first portion 24 of the sleeve 14 is positioned at the bend in the pipeline 11 so the components of the assembly 13 expands there first. This helps to ensure the liner 10 expands radially outward toward the pipe 11 at the bend before the ends of the assembly 13 expand radially outward toward the pipe 11. Expanding the assembly 13 at the bend before expanding on either side of the bend helps to minimize fluid (water or air) pockets trapped between the liner 10 and the pipe 11 at the bend. In other words, any fluid between the liner 10 and the pipe 11 will be pushed outward toward an end of the assembly 13 as the assembly 13 expands first at the bend then serially outward (longitudinally) toward its ends. FIG. 5 shows the repair assembly 13 before inflation, FIG. 6 shows the repair assembly partially inflated, and FIG. 7 shows the repair assembly fully inflated.

In use, a sleeve 14 is prepared having a first portion 24 with a first (larger) diameter D1 and a second portion 26 with a second (smaller) diameter D2. Then, positioning the sleeve 14 over the bladder 12. Impregnating the liner 10 with a resin capable of curing and hardening, then positioning the liner 10 over the sleeve 14. Positioning the assembly 13 in the pipe 11 at a damaged portion needing repair, then inflating the bladder 12 using fluid pressure causing the assembly to expand outward toward the inside wall of the pipe 11. In some embodiments the assembly 13 is positioned in the pipe so the first portion 24 of the sleeve 14 is positioned within a bend or curve in the pipe 11. The first portion 24 of the sleeve 14 having the larger diameter expanding first causing the bladder 12 to urge the liner 10 toward at the pipe at the first portion 24 of the sleeve 14. Any air or fluid between the liner 10 and the pipe 11 is conveyed from the first portion 24 of the sleeve 14 outward toward the end portions 30 of the assembly 13 instead of becoming trapped between the liner 10 and the pipe 11. Continuing to expand the assembly 13 until the remaining portions of the assembly 13 are properly positioned. In some embodiments the assembly 13 can be used to move fluid, such as water, to another location. For example, the first portion 24 of the sleeve 14 may be positioned at an end of the assembly 13. Upon inflation the assembly 13 expands toward the inner pipe 11 wall at the first portion 24 of the sleeve 14 first, then expands serially away from the first portion 24. In this manner the assembly 13 can be used to convey or squeegee water between the pipe 11 wall and the serially expanding assembly 13 from a first location to a second location. After the liner 10 has cured and hardened, removing the packer, bladder 12, and sleeve 14 from the pipe 11.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

What is claimed is as follows:

1. A sleeve for use with a repair assembly for repairing a pipeline, said sleeve comprising:
a first portion having a first diameter and a second portion having a second diameter, the first diameter is greater than the second diameter.

2. The sleeve of claim 1 wherein the sleeve is an integrated bladder sleeve.

3. The sleeve of claim 1 further comprising a tapered portion between the first portion and the second portion, the tapered portion having a plurality of diameters which decrease from the first portion to the second portion.

4. The sleeve of claim 1 wherein the first portion and the second portion are in the shape of a prolate spheroid.

5. The sleeve of claim 1 further comprising a center portion positioned between two end portions, and the first portion is at the center portion.

6. The sleeve of claim 1 further comprising a center portion positioned between two end portions, and the first portion is at one of the end portions.

7. The sleeve of claim 1 further comprising a circumference, and a plurality of openings in the sleeve around the circumference.

8. A repair assembly for repairing a pipeline, the repair assembly comprising:
a bladder;
a sleeve at least partially surrounding the bladder, the sleeve comprising a first portion having a first diameter and a second portion having a second diameter, the first diameter is greater than the second diameter.

9. The repair assembly of claim 8 further comprising a liner at least partially surrounding the bladder, the liner configured to be impregnated with a resin capable of curing and hardening.

10. The repair assembly of claim 8 wherein the bladder and the sleeve are made from a light-permeable material.

11. The repair assembly of claim 8 further comprising a lighting assembly positioned within the bladder.

12. The repair assembly of claim 8 wherein the bladder and the sleeve are combined to form an integrated bladder sleeve.

13. The repair assembly of claim 9 wherein the liner has a length and the first portion of the sleeve has a length, and the length of the liner is about the same as the length of the first portion of the sleeve.

14. The repair assembly of claim 8 wherein the bladder is part of a packer.

15. The repair assembly of claim 8 wherein the sleeve further comprising a circumference, and the sleeve further comprises a plurality of openings in the sleeve around the circumference.

16. The sleeve of claim 8 further comprising a tapered portion between the first portion and the second portion, the tapered portion having a plurality of diameters which decrease from the first portion to the second portion.

17. A method of repairing a pipeline, said method comprising:
taking a repair assembly having a resin impregnable liner, an inflatable bladder, and a sleeve, wherein the sleeve comprises a first portion having a first diameter and a second portion having a second diameter, the first diameter is greater than the second diameter;
positioning the sleeve at least partially around the bladder;
impregnating the liner with a resin capable of curing and hardening;
positioning the liner at least partially around the sleeve;
positioning the repair assembly in the pipeline;
inflating the bladder using fluid pressure to cause the repair assembly to expand radially outward toward the pipeline along the first portion of the sleeve, then continuing to inflate the bladder using fluid pressure to cause the repair assembly to expand radially outward toward the pipeline along the second portion of the sleeve;
removing the bladder and sleeve from the pipeline after the liner has cured and hardened.

18. The method of claim 17 further comprising positioning the repair assembly in the pipeline so the first portion of the sleeve is positioned within a bend in the pipeline.

19. The method of claim 17 wherein the repair assembly further comprises a lighting assembly at least partially within the bladder, and the method further comprises activating the lighting assembly to begin curing the resin.

20. The method of claim 17 wherein the repair assembly includes a middle portion between two end portions and the first portion of the sleeve is near the middle portion, and the step of continuing to inflate the bladder includes causing the repair assembly to expand radially outward toward the pipeline serially longitudinally away from the first portion toward the end potions of the assembly.

21. The method of claim 17 wherein the sleeve includes a plurality of openings and there is fluid between the bladder and the sleeve, and the method further comprises causing the fluid to be expelled through the openings as the bladder is inflated.
